(19) United States
(12) Patent Application Publication
(10) Pub. No.: US 2010/0001841 A1
(43) Pub. Date: Jan. 7, 2010

(54) DYNAMICALLY DISTRIBUTABLE NANO RFID DEVICE AND RELATED METHOD

(76) Inventor: Mario W. CARDULLO, Alexandria, VA (US)

Correspondence Address: MCGUIREWOODS, LLP, 1750 TYSONS BLVD, SUITE 1800, MCLEAN, VA, 22102, US

(21) Appl. No.: 12/498,689

(22) Filed: Jul. 7, 2009

Related U.S. Application Data
(60) Provisional application No. 61/078,627, filed on Jul. 7, 2008.

(51) Int. Cl. H04Q 5/22

(52) U.S. Cl. 340/10.1

(57) ABSTRACT

A nano RFID device or tag and method for using same are disclosed. The nano RFID device may be less than about 150 nanometers in size. The nano RFID device may be a passive, active or semi-passive nano RFID device. The nano RFID device may be distributed to a target such as a human or animal or products, for example. The nano RFID device may include an nano antenna that may comprise one or more carbon tubes. The nano RFID device may include a nano battery. The nano RFID device may include an environmentally reactive layer that reacts to its immediate environment to affix or adhere to a target. The nano RFID device may be constructed for direct or indirect distribution techniques such as by airborne techniques for inhalation, consumption distribution for ingestion, and contact distribution, for example.

### CROSS-REFERENCE TO RELATED APPLICATIONS

This application claims benefit and priority to U.S. Provisional Application Ser. No. 61/078,627, filed Jul. 7, 2008, entitled “DYNAMICALLY DISTRIBUTABLE NANO RFID DEVICE AND RELATED METHOD,” the disclosure of which is incorporated by reference herein.

### BACKGROUND OF THE INVENTION

1. Field of the Invention

The invention is directed generally to a device and method for nano radio frequency identification (RFID) and, more specifically, to a nano RFID device and method for dynamically distributing the nano RFID device to facilitate dynamic tracking and/or identification of people and/or animals, including situations related to covert tracking.

2. Related Art

The commercial world has seen the rise of different systems and methods for tracking items such as packages or shipping containers, often using radio frequency identification (RFID) technology. However, there are few practical techniques for tracking people or animals in a dynamic manner. In particular, there are few techniques for tracking people or animals, especially when a need to do so may be related to a covert need or situation.

Most RFID tags typically contain at least two parts. One is an integrated circuit for storing and processing information, modulating and demodulating a radio frequency (RF) signal, and other specialized functions. The second part is an antenna for receiving and transmitting the signal. A technology called chipless RFID allows for discrete identification of tags without an integrated circuit, thereby allowing tags to be printed directly onto assets at a lower cost than traditional tags.

Passive RFID tags typically have no internal power supply. The electrical current induced in the antenna by the incoming radio frequency signal provides just enough power for the CMOS integrated circuit in the tag to power up and transmit a response. Most passive tags signal by backscattering a carrier wave from a reader. This necessitates that the antenna has to be designed both to collect power from the incoming signal and also to transmit the outbound backscatter signal. The response of a passive RFID tag is not necessarily just an ID number; the tag chip can contain non-volatile, perhaps writable EEPROM for storing data.

Semi-passive tags are similar to active tags in that they have a power source, but may only power the micro-circuitry and may not power the broadcasting of the signal. The response may be powered by the backscattering of the RF energy from the reader.

However, the current technology for all these types of tags, passive and active, still may require relatively “large” physical packaging. Because of the size constraints, applications requiring RFID technology may be unduly restrictive.

Accordingly, there is a need for a method and device for providing RFID technology with a smaller form factor enabling dynamic tracking applications of people and/or animals.

### SUMMARY OF THE INVENTION

The invention meets the foregoing need and provides for a nano RFID device and related method suitable for use in applications requiring a tracking device of a few hundred nanometers or smaller in size. The nano RFID device constructed according to principles of the invention may be embedded or distributed to a target including humans, animals, compositions, fabrics, objects, or the like. In some applications, the nano RFID device as constructed according to principles of the invention may be distributed for inhalation or ingestion by a target. The nano RFID device when constructed according to the inventive principles herein, may include an environmentally reactive layer to cause adhesion or attachment to a target.

Accordingly, in one aspect of the invention, a nano radio frequency identification (RFID) device is provided that includes a radio frequency (RF) section configured to be responsive to an RF signal, and an antenna operatively coupled to the RF section to receive the RF signal and to emit a response, a layer surrounding at least one of the RF section and the antenna, wherein the nano RFID device is configured to be less than about 150 nanometers in width, length and thickness.

In another aspect, a method for using a nano radio frequency identification (RFID) device, the nano RFID device includes a radio frequency (RF) section configured to be responsive to an RF signal, and an antenna operatively coupled to the RF section to receive the RF signal and to emit a response, wherein the nano RFID device is configured to be less than about 150 nanometers in width, length and thickness, the method includes storing identification data within the nano RFID device, distributing the nano device to a target, and tracking the nano device by using the emitted response.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is a block diagram of an embodiment of a nano RFID device constructed according to principles of the invention;

FIG. 2 is a block diagram of another embodiment of a nano RFID device constructed according to principles of the invention;

FIG. 3 is a block diagram of another embodiment of a nano RFID device constructed according to principles of the invention;

FIG. 4 is a flow diagram of an exemplary process performed according to principles of the invention and using a nano RFID device constructed according to principles of the invention, such as the nano RFID devices shown in relation to FIGS. 1-3;

FIG. 5 is a flow diagram showing exemplary steps for using the nano RFID tag, constructed according to principles of the invention; and

FIG. 6 is another flow diagram showing exemplary steps for using a nano RFID tag, constructed according to principles of the invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The method and device of the invention includes providing a nano radio frequency identification (RFID) device (RFID tag) of about 150 nanometers or smaller in dimension. In some embodiments, the RFID device may include semiconductors as small as is 90-nm, perhaps with some chips configured and provided at the 65-nm, 45-nm and/or 30-nm size level, in view of the current cutting edge state-of-the-art in nano-fabrication. The technology for the included electrical circuitry may include CMOS or related technology for low power consumption. A nano RFID device constructed by nanotechnology techniques provides advantages over the currently available RFID devices such as permitting the RFID device to be distributed by airborne, ingestion, or contact distribution (perhaps by aerosol or a mist, for example), or constructed to react to an specific environmental factor for embedded/affixing to a surface or specific type of material (e.g., an organic material). This provides for dynamic distribution of the RFID device to track targeted subjects or objects.

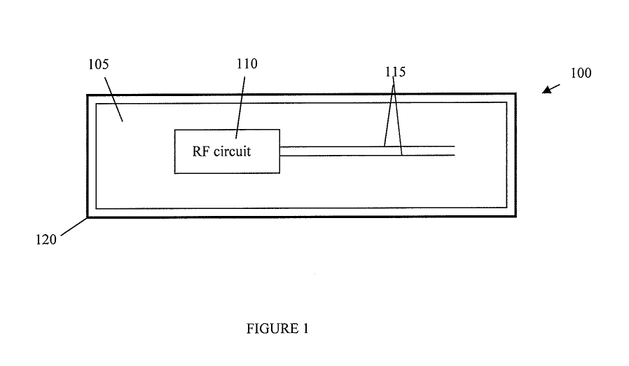

FIG. 1 is a block diagram of an embodiment of a passive nano RFID component, generally denoted by reference numeral 100. The component 100 may include a nano RFID device 105 that may include a radio frequency circuit (RF) 110 that may be configured to respond to a received RF signal and to provide identifying information of the nano RFID device 105 which may be associated with a composition, item, product, person, or similar object, when triggered by the received RF signal. The identifying information may be electronically encoded alphanumeric data to uniquely or non-uniquely identify the nano-RFID device 105. The RF circuit 110 may also be configured with a memory (not shown), such as EEROM or EEPROM, for example, to store other information that may be transmitted along with the identifying information. The nano RFID device 105 may also include antennae 115 that may receive an RF signal and also emit a response signal as generated by the RF circuit 110. The antennae 115 may be at least one, preferably two, carbon nano tubes or other nano materials suitable for RF reception and emission such as transmitting the outbound backscatter signal. Also shown as part of the general nano RFID component 100 is a layer 120, such as a plastic coating or other suitable composition that provides environmental protection for the nano-RFID device 105, and/or provides an adhering or attaching property as discussed more fully below. The nano-RFID device 105 may have a size of about 150 nanometers, or smaller, in all dimensions (length, width and thickness).

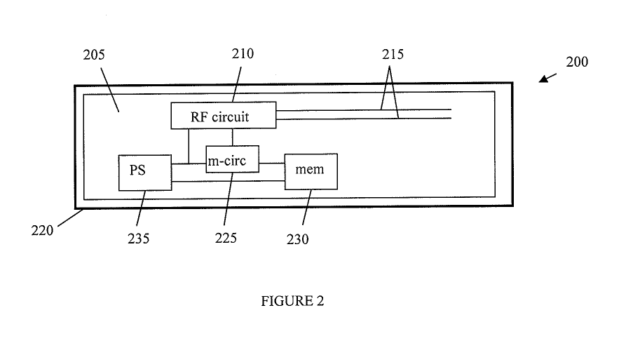

FIG. 2 is a block diagram of an embodiment of active nano RFID component, generally denoted by reference numeral 200. The nano RFID component 200 may include an active nano RFID device 205 and may include a radio frequency circuit (RF) 210 that is configured to receive a RF signal and configured to emit data as initiated by the RF circuit 210 or as initiated by the micro-circuit 225 (which may comprise a micro-processor, or the like) that provides additional processing and control capability. The emitted data may include identifying information of the active nano RFID device 205, which may be associated with a composition, item, product, person, or similar object. The identifying information may be electronically encoded alphanumeric data to uniquely identify the nano-RFID device 205. The active nano device 205 may also be configured with a memory 230, such as EEROM or EEPROM, for example, to store the identifying data, and/or other information that may be transmitted along with the identifying information.

The active nano device 205 may also include a nano power source 235 such as a nano battery, for example. The power source 235 may be fabricated as a nano chemical-battery or nano bio-battery, as is known in the art. The power source 235 may be configured to provide power to the RF circuit 210, micro-circuit 225 and memory 230. The power source 235 may provide sufficient power to cause a stronger response signal, hence greater transmission distances, as compared with a passive nano RFID device, such as shown in relation to FIG. 1, for example. Antennae 215 may receive an RF signal and also emit a response signal as generated by the RF circuit 210 that may be initiated by the micro-circuit 225. The antennae 215 may be at least one, preferably two, carbon nano tubes or other nano materials suitable for RF reception and emission such as transmitting the outbound backscatter signal. Also, the nano RFID component 200 may involve a layer 220, such as a plastic coating or other suitable composition that provides environmental protection for the nano-RFID device 205 and/or provides suitable adhering properties for attaching or imparting the nano RFID component 200 to a subject, as described more below. The RF circuit 210 and the micro-circuit 225 may be combined in some embodiments. The nano device 205 may have a size of about 150 nanometers, or smaller, in all dimensions (length, width and thickness).

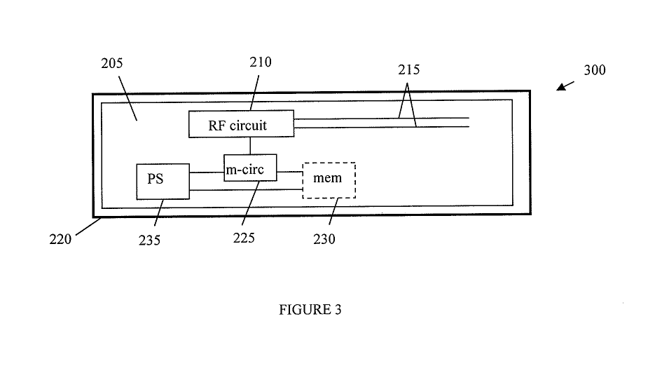

FIG. 3 is a block diagram of an embodiment of a semi-passive nano RFID component, generally denoted by reference numeral 300. The embodiment of FIG. 3 may be configured similarly to the device of FIG. 2, except that the nano power source 235 may not power the response signal, rather the response signal may be provided in the same manner as a passive nano RFID device (such as shown in FIG. 1, for example) by backscatter techniques. However, in some aspects, the RF circuit 210 may be powered at least in part by the nano power source 235 for interacting with the micro-circuit 225 for exchange of information (perhaps as contained in memory 230), such as identification data, and so that the exchanged information may be transmitted (or received by micro-circuit 225), as appropriate. The nano RFID component 300 excluding protective layer 220 may have a size of about 150 nanometers, or smaller, in all dimensions (length, width and thickness).

In one aspect, the nano RFID component of FIGS. 1-3 may be constructed having a layer 120, 220 that facilitates affixing the nano RFID component (e.g., 100, 200) to a subject or target. The layer at least surrounds the circuitry (e.g., RF section), preferably it surrounds both the circuitry and the antennae. (Moreover, the layers 120, 220 may be optional, depending on intended application usage). For example, a plurality of nano RFID components may be configured with identical indicia and distributed by broadcasting to a selected target or targets. The broadcasting may be airborne distribution (e.g., for inhalation), contact distribution including injection/insertion, ingestion distribution (e.g., by drinking or eating), and the like.

By way of an example, the layer 120, 220 may include nano claws (e.g., analogous to the functional properties of Velcro®) that may adhere to clothing, hair, skin and the like. Another example of layer 120, 220 may include an inorganic or organic type of adhesive (e.g., a bioglue, biological adhesives, and the like) that bonds the nano RFID component 100, 200 to a subject (human, animal or possible an inanimate object). In some applications, the layer 120, 220 may activate adherence properties upon contact with, or in the presence of, human or animal organic properties such as skin oils, body fluids, body excretions (e.g., perspiration, saliva and the like), body proteins (e.g., hair, skin, blood, and the like). Generally, when the layers 120, 220 are constructed to respond in some way to immediate environment characteristics, the layers may be generally referred to as environmentally reactive layers.

In other aspects, the layer 120, 220 may also be activated when the layer comes into contact with a surface or material at a specific temperature range such as at human body temperature, for example, perhaps within a range of a pre-determined amount of degrees and/or in combination with moisture, for example. In this way, a higher degree of success may be achieved when targeting the nano RFID component to a subject.

For still other aspects, the layer 120, 220 may be constructed with an adhering property that is responsive to internal body conditions such as the lungs. For example, if a subject were to inhale one or more of the distributed (perhaps by way of airborne aerosol or mist) nano RFID components (100, 200), the layer 120, 220 may be activated in the presence of specific enzymes or hormones (or other compounds) present in the lungs. Alternatively, or in addition, the layer 120, 220 may also be constructed to respond to moisture and/or a temperature range as found in lungs. Another example, may include when a nano RFID component 120, 220 is ingested, the stomach acids may activate the layer 120, 220.

Moreover, the nano RFID device 105, 205 may be dynamically activated for responding to a RFID trigger query. That is, the nano RFID device may be inhibited initially when configured so that it appears to be a “dead” device, but in the presence of specific environmental triggers (e.g., the lungs, stomach, proteins, fluids, compounds, temperatures, and similar environmental triggers) the device 105, 205 may change internal state and become “active” and begin responding (by providing internal data) to external RFID triggers (i.e., when an external trigger is detected by the nano RFID device). This “dead” and subsequent “active” capability may prevent or reduce inadvertent detection of the nano RFID device until successfully implanted into or affixed to a target, as described previously.

In certain aspects, this “awakening” stimulus of a “dead” nano RFID device 105, 205 may be associated with or depended upon the activation of layer 120, 220, as described previously. That is, when layers 120, 220 may be activated by a specific environmental condition, the device 105, 205 may also be dynamically activated and configured to respond to any subsequently detected external RFID trigger, or alternatively, to begin transmitting identification information without a need for a trigger.

In some applications, the layers 120, 220 may also be constructed with magnetic or electrostatic properties for adhering to specific types of materials, or in specific environmental conditions. The layers 120, 220 may include a combination of properties, e.g., chemically reactive, electrostatic and/or magnetic, to increase chances of adhering to an intended target.

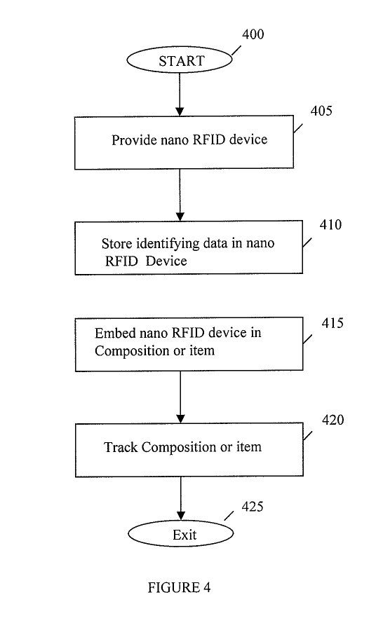

FIG. 4 is a flow diagram of steps for using an embodiment of a nano-RFID device of FIGS. 1, 2 and 3, according to principles of the invention, starting at step 400. At step 405, a nano RFID device (i.e., nano RFID tag) may be provided, such as any of the nano RFID devices shown in relation to FIGS. 1-3. At step 410, the nano RFID device may be initialized with identifying data which may or may not be unique (i.e., more than one RFID device may have common subset, or a same identifier). At step 415, the nano RFID device may be embedded into a subject, composition or material, item, or product, or distributed to affix to a subject. At step 420, the subject, composition, material, product or similar object may be tracked by RFID techniques and the resulting identification information received by the RFID exchange processed according to an application or system using the nano RFID device. This may include correlating a date and time of distribution of the RFID device, as may be previously recorded, to determine a probable movement of the subject, object, item, material and to be used in an tracking analysis, perhaps providing an identification by circumstances. At step 425, the process ends.

In some aspects, the identification information within a nano RFID device 105, 205 may be duplicated among more than one nano RFID device (perhaps thousands, or more, in some applications), so that more than one nano RFID device may have the same identification information, or at least a subset of the same information. This may be useful when distribution of the nano RFID device is to be accomplished by way of a broadcast methodology, for example, and multiple nano RFID devices may be needed with identical information to assure that at least one reaches a target or set of targets that may be located within a target zone.

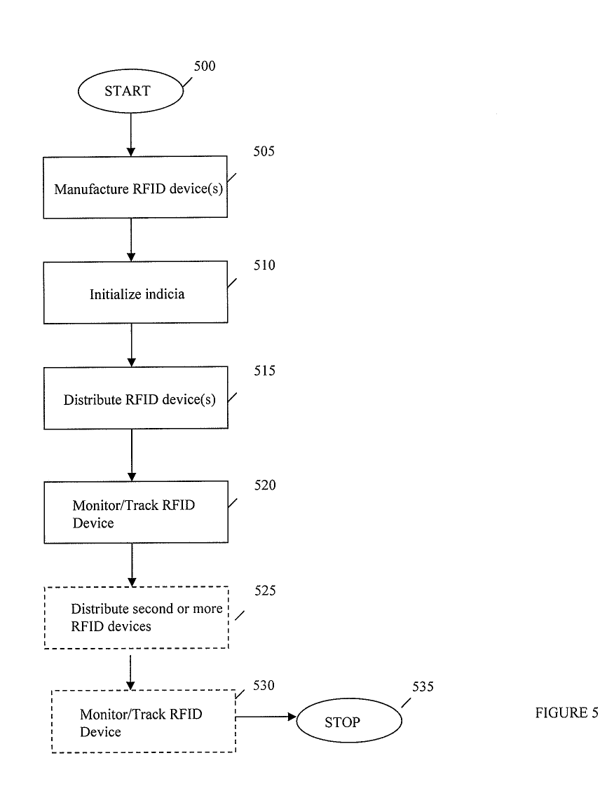

FIG. 5 is a flow diagram showing exemplary steps for using a nano RFID tag, constructed according to principles of the invention, starting at step 500. At step 505, one or more nano RFID tags may be constructed according to principles of the invention, such as described in relation to FIGS. 1-3. The nano RFID tags may be constructed with any suitable layer 120, 220, as described previously, depending on application, including environmental reactive layers. In some applications, layer 120, 220 may be unnecessary.

At step 510, the one or more nano RFID tags may be initialized with identifying indicia suitable for an application and might include any of: a serial number, a name, a date, a time, a location (e.g., country or GPS coordinate), and the like. The one or more nano RFID tags may be uniquely identified, or may have a common set of indicia. The RFID devices may also be configured to actively send identifying information, with or without being triggered.

At step 515, the initialized one or more nano RFID tags may be distributed, broadcasted or delivered to one or more targets (e.g., human, animal, or inanimate object). The delivery may be accomplished in nearly any suitable manner, including direct contact with or insertion into the target, or indirect delivery through a channel such as a food channel, water channel, or airborne channel and the like.

At step 520, a system of tracking the nano RFID tags may be deployed suitable for the application. This may include deploying RFID transponders to receive information from the RFID devices and/or for triggering the nano RFID devices to respond with internal information. These RFID transponders may be deployed at nearly any location including, for example, private or public transit points such as a home, a place of business or gatherings, airports, ships, planes, ports of entry, car rental locations, train depots, buildings, trails, and the like. Virtually any location may be equipped with a RFID transponder for detecting and reading a RFID tag.

At optional step 525, a second distribution of RFID tags may be performed, perhaps having different indicia from the first set of RFID tags as distributed at step 515. In this manner, a subset of targets from the distribution activity of step 515 may be re-tagged or additionally tagged, so that a subset of the initially tagged targets may be tracked. This may be beneficial for statistically monitoring movement of sets of targets or to identify a selected subset's movement over time. Other subsets of targets may be tagged as necessary. At step 530, the second distribution of tags may be tracked. At step 535, the process ends.

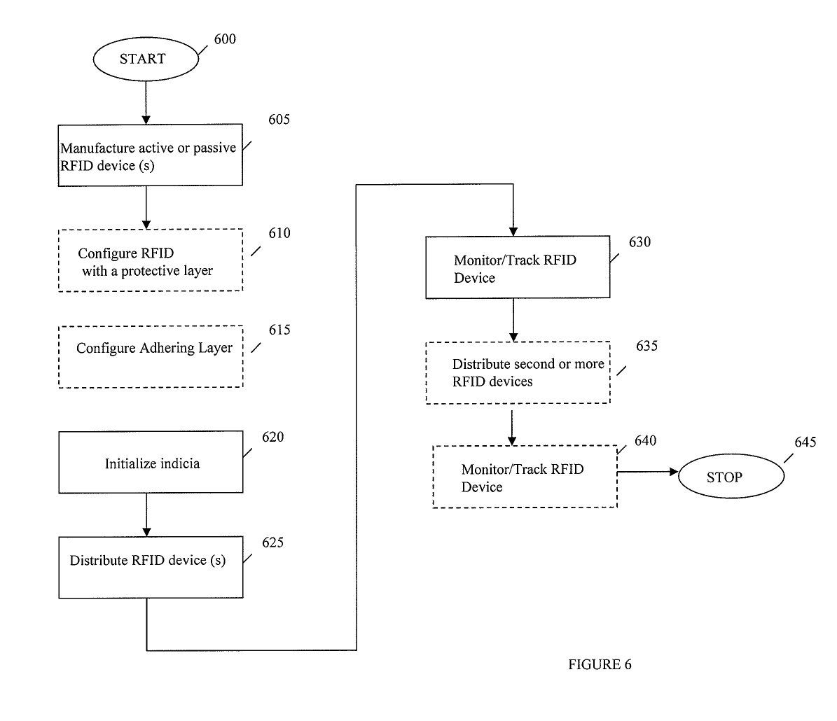

FIG. 6 is a flow diagram showing exemplary steps for using a nano RFID tag, constructed according to principles of the invention, starting at step 600. At step 605, one or more nano RFID tags may be constructed according to principles of the invention, such as described in relation to FIGS. 1-3, and may be constructed as a passive or active RFID tag, perhaps depending on intended usage, for example. At optional step 610, the nano RFID tags may be constructed with layer 120, 220, which may be a protective layer for protecting the RFID tag from environmental factors. In some intended applications, layer 120, 220 may be unnecessary. At optional step 615, an adhering layer may be configured with properties that facilitate adherence of the RFID tag to a subject. These properties may include one or more of electrostatic, chemical, bio-reactive, moisture sensitive and responsive, light reactive, or the like. In some applications, a combination of properties may be employed, such as, for example, a first layer to react to moisture that in term permits a second bio-adhesive layer to begin adherence. Many versions and types of bio-adhesives are commonly known in the medical and dental fields.

At step 620, the one or more nano RFID tags may be initialized with identifying indicia suitable for an application and might include at least any of: a serial number, a name, a date, a time, a location (e.g., country or GPS coordinate), and the like. The one or more nano RFID tags may be uniquely identified, or may have a common set of indicia. The RFID devices may also be configured to actively send identifying information, with or without being triggered.

At step 625, the initialized one or more nano RFID tags may be distributed, broadcasted or delivered to one or more targets (e.g., human, animal, and/or inanimate object). The delivery may be accomplished in nearly any suitable manner, including direct contact with or insertion into the target, or indirect delivery through a channel such as a food channel, water channel, or airborne channel and the like.

At step 630, a system of tracking the nano RFID tags may be deployed geographically suitable for the specific application. This may include deploying RFID transponders to receive information from the RFID devices and/or for triggering the nano RFID devices to respond with internal information. These RFID transponders may be deployed at nearly any location including, for example, private or public transit points such as a home, a place of business or gatherings, airports, ships, planes, ports of entry, car rental locations, train depots, buildings, trails, and the like. Virtually any location may be equipped with a RFID transponder for detecting and reading a RFID tag.

At optional step 635, a second distribution of RFID tags may be performed, perhaps having different indicia from the first set of RFID tags as distributed at step 630. In this manner, a subset of targets from the distribution activity of step 630 may be re-tagged or additionally tagged, so that a subset of the initially tagged targets may be tracked. This may be beneficial for statistically monitoring movement of sets of targets or to identify a selected subset's movement over time. Other subsets of targets may be tagged as necessary. At optional step 640, the second distribution of tags may be tracked. At step 645, the process ends.

Related technology that may provide an expanded description of various techniques and principles herein may be found in one or more publications such as, for example: “Nanophysics and Nanotechnology: An Introduction to Modem Concepts in Nanoscience,” Edward L. Wolf, Wiley-VCH; 2 edition (October 2006); “Springer Handbook of Nanotechnology,” Springer, 2nd rev. and extended ed. edition (March 2007); “Introduction to Nanoscale Science and Technology (Nanostructure Science and Technology),” Springer, 1^{st} edition (June 2004); “Fundamentals of Microfabrication: The Science of Miniaturization,” Marc J. Madou, CRC, 2 edition (Mar. 13, 2002); “RFID Essentials (Theory in Practice),” O'Reilly Media, Inc. (January 2006); “RFID Applied” by Jerry Banks, David Hanny, Manuel A. Pachano, Les G. Thompson, Wiley (Mar. 30, 2007); “Carbon Nanotubes: Properties and Applications” by Michael J. O'Connell, CRC (May 2006); and “Nanoscale Science and Technology” by Robert Kelsall, Ian Hamley, Mark Geoghegan, Wiley (April 2005), all of which are incorporated by reference in their entirety.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention. Moreover, any document, publication or patent referred to herein is incorporated by reference in its entirety.

What is claimed is:

1. A nano radio frequency identification (RFID) device, comprising:
a radio frequency (RF) section configured to be responsive to an RF signal;
an antenna operatively coupled to the RF section to receive the RF signal and to emit a response; and
a layer surrounding at least one of the RF section and the antenna,
wherein the nano RFID device is configured to be less than about 150 nanometers in width, length and thickness.

2. The nano RFID device of claim 1, wherein the layer comprises a protective covering to protect the nano RFID device.

3. The nano RFID device of claim 1, wherein the layer comprises an environmentally reactive layer.

4. The nano RFID device of claim 1, wherein the layer is constructed to facilitate attaching to, or embedding in, a target

5. The nano RFID device of claim 1, wherein the RFID device is distributable by airborne delivery and is inhalable by at least one target.

6. The nano RFID device of claim 1, wherein the RF section is configured to respond by backscattering a received signal.

7. The nano RFID device of claim 1, wherein the RF section is configured to respond with data identifying the nano RFID device.

8. The nano RFID device of claim 1, wherein the nano RFID device is configured to provide tracking information.

9. The nano RFID device of claim 1, wherein the nano RFID device comprises a passive RFID device.

10. The nano RFID device of claim 1, wherein the antenna comprises at least one nano carbon tube.

11. The nano RFID device of claim 1, wherein the nano RFID device is a RFID tag.

12. The nano RFID device of claim 1, further comprising a micro-circuit to process the received signal.

13. The nano RFID device of claim 9, further comprising a memory operatively coupled to the micro-circuit to store identification data.

14. The nano RFID device of claim 1, further comprising a nano power source.

15. The nano RFID device of claim 14, wherein the power source is a nano bio-battery.

16. The nano RFID device of claim 14, wherein the nano power source powers the RF section for emitting the response.

17. The nano RFID device of claim 14, wherein the nano power source powers the RF section at least in part and the emitted response is emitted by backscatter.

18. The nano RFID device of claim 1, wherein the RF section is dynamically configurable to be responsive or non-responsive to an RF signal.

19. The nano RFID device of claim 18, wherein the RF section is dynamically configurable to be responsive or non-responsive to an RF signal based on a state of the layer.

20. A method for using a nano radio frequency identification (RFID) device, the nano RFID device comprising:
a radio frequency (RF) section configured to be responsive to an RF signal; and
an antenna operatively coupled to the RF section to receive the RF signal and to emit a response,
wherein the nano RFID device is configured to be less than about 150 nanometers in width, length and thickness, the method comprising the steps of:
storing identification data within the nano RFID device;
distributing the nano device to a target for association with the target; and
tracking the nano device by using the emitted response.

21. The method of claim 20, wherein the RFID device is configured to be affixed to a human or animal target.

22. The method of claim 20, wherein the step of distributing includes airborne distributing of the nano RFID device.

23. The method of claim 20, wherein the step of distributing includes contact distribution of the nano RFID device.

24. The method of claim 20, wherein the emitted response includes the identification data.

25. The method of claim 20, further comprising the step of adhering the nano RFID device to the target.

26. The method of claim 25, wherein the step of adhering is achieved by an environmentally reactive layer of the nano RFID device.

27. The method of claim 26, wherein the step of adhering includes a biological adhesive.

28. The method of claim 25, wherein the step of adhering includes one of a magnetic adherence technique and electrostatic adherence technique

29. The method of claim 20, wherein the step of distribution causes the association with the target by way of ingestion.

30. The method of claim 20, wherein the step of distribution causes the association with the target by way of inhalation.

31. The method of claim 20, wherein the step of distribution causes the association with the target by way of insertion into the target.

32. The method of claim 20, wherein the nano RFID device further comprises a layer surrounding at least the radio frequency (RF) section.

33. The method of claim 32, wherein the layer comprises at least any one of: an environmentally reactive layer, a magnetically enabled layer, an electrostatically enabled layer, a mechanically configured layer to cause adherence.

34. The method of claim 32, wherein the layer comprises a protective layer.

35. An item including the nano RFID device of claim 1.
